(19) United States
(12) Patent Application Publication
(10) Pub. No.: US 2026/0097376 A1
(43) Pub. Date: Apr. 9, 2026

(54) MULTISTAGE CATALYTIC REACTION SYSTEM FOR SIMULTANEOUS CONVERSION OF HYDROCARBONS OF VARIOUS CARBON NUMBERS

(71) Applicant: KOREA INSTITUTE OF ENERGY RESEARCH, Daejeon (KR)

(72) Inventors: Hee-yeon KIM, Daejeon (KR); Minseon CHOI, Iksan-si (KR); Sojung KIM, Sejong-si (KR); Cha Heon KIM, Seosan-si (KR)

(73) Assignee: KOREA INSTITUTE OF ENERGY RESEARCH, Daejeon (KR)

(21) Appl. No.: 19/009,578

(22) Filed: Jan. 3, 2025

(30) Foreign Application Priority Data
Oct. 8, 2024 (KR) 10-2024-0136498

(51) Int. Cl. B01J 8/04; B01J 21/04; B01J 23/755; C01B 3/38; C01B 3/40

(52) U.S. Cl. CPC B01J 8/0492; B01J 21/04; B01J 23/755; C01B 3/382; C01B 3/40; C01B 2203/0238; C01B 2203/1058; C01B 2203/1082; C01B 2203/1247; C01B 2203/1252; C01B 2203/143

(57) ABSTRACT

The present disclosure relates to a multistage catalytic reaction system for simultaneous conversion of hydrocarbons having various carbon numbers. Particularly, the present disclosure relates to a catalytic reaction system for producing hydrogen or syngas, which is a mixture of hydrogen with carbon monoxide, by mixing C₁-C₆ hydrocarbons having various carbon numbers, including paraffins (CₙH₂ₙ₊₂), naphthenes (CₙH₂ₙ), olefins (CₙH₂ₙ), diolefins (CₙH₂ₙ₋₂), and acetylenes (CₙH₂ₙ₋₂) with carbon dioxide at a predetermined ratio, and carrying out reaction thereof. In the multistage reaction system, each reaction zone is maintained under a different reaction condition. Therefore, when using the multistage reaction system, hydrocarbon reactants of various compositions emitted from the actual industry can be treated simultaneously through a one-step process, thereby providing hydrogen or syngas of high value at high yield, while saving processing costs significantly.

### CROSS-REFERENCE TO RELATED APPLICATION

This application claims priority to Korean Patent Application No. 10-2024-0136498, filed on Oct. 8, 2024, and all the benefits accruing therefrom under 35 U.S.C. § 119, the contents of which in its entirety are herein incorporated by reference.

### BACKGROUND

### 1. Field

The present disclosure relates to a multistage catalytic reaction system for simultaneous conversion of hydrocarbons having various carbon numbers. Particularly, the present disclosure relates to a catalytic reaction system for producing hydrogen and syngas through one-step dry reforming of mixed hydrocarbons having various carbon numbers. The catalytic reaction system of the present disclosure treats mixed hydrocarbons containing various components by a one-step process including multiple stages through a multistage reactor, each reaction zone of which is set under a different reaction condition, while not being subjected to a separate purification step, thereby providing hydrogen or syngas of high value at high yield.

### 2. Description of the Related Art

Dry reforming is a reaction for producing hydrogen and carbon monoxide by using methane and carbon dioxide, which are typical greenhouse gases, as reactants and is one of the most effective processes for carbon neutrality. Dry reforming according to the related art is applied mainly to methane (CH₄) having one carbon atom. However, the byproduct gas actually emitted in an industrial process includes various hydrocarbons having two or more carbon atoms. When dry forming is carried out by using carbon dioxide as a reactant together with such a byproduct gas, useful hydrogen and carbon monoxide can be obtained by using greenhouse gases as reactants. Therefore, this is significantly useful as a technology to respond to global warming.

Particularly, carbon dioxide used as a reactant in a dry reforming process is carbon dioxide raw material collected from a source, such as an industrial byproduct gas, which helps to respond to carbon neutrality and a climate change and is significantly useful in terms of saving of raw material and processing costs of hydrogen and syngas.

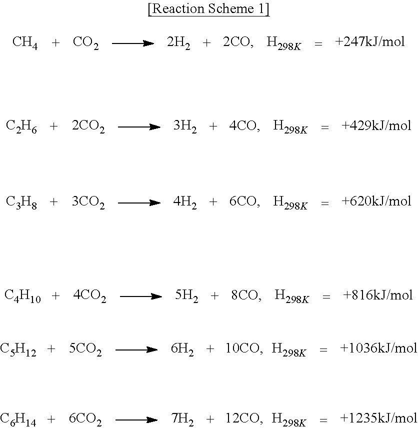

Reaction Scheme 1 represents dry reforming formulas of alkane-type hydrocarbons having 1-6 carbon atoms. All dry reforming reactions of typical hydrocarbons, such as alkane-type methane, ethane, propane, butane, pentane and hexane, are endothermic reactions and commonly require heat supply from the outside for reaction progress and show a tendency of requiring a higher reaction temperature as the number of carbon atoms decreases. In addition, a paraffin-type hydrocarbon having single bond(s) tends to require a higher reaction temperature as compared to the other types of hydrocarbons, including olefin-type hydrocarbons (having one double bond) or acetylene-type hydrocarbons (having one triple bond), diolefin-type hydrocarbons (having two double bonds) and naphthene-type hydrocarbons (cyclic compounds). Therefore, it is effective for processing cost saving and is favorable to easy operation that an integral reaction system in which multistage reactors maintaining different temperatures are combined is used for the purpose of simultaneous conversion of mixed gases having various carbon numbers.

C₁, C₂, C₃ and C₄ hydrocarbons are emitted as byproduct gases actually in the industrial processes, and C₅-C₆ hydrocarbons having a larger carbon number are emitted in combination in some processes. However, when such hydrocarbons are individually separated, before being fed into a treatment step, and fed into each step, excessively high processing costs are required and an extremely large factory area (site) is also required. In order to treat byproduct gases containing a mixture of various hydrocarbons simultaneously through a one-step process with no separate pretreatment or separation step, a series of catalytic conversion steps through a multistage catalytic reaction system in which reactors using different processing conditions suitable for different carbon numbers and bonding types (paraffin type, olefin type, acetylene type, diolefin type, naphthene type, etc.) of hydrocarbons contained in reactants are connected sequentially may be applied to convert the reactants containing various hydrocarbons, such as C₁-C₆ hydrocarbons, into hydrogen and carbon monoxide merely through one step.

For example, when a hydrocarbon reactant having a large carbon number, such as a C₆ hydrocarbon, is converted, compounds having a smaller carbon number, such as C₁, C₂, C₃ and C₄ compounds, may be produced as byproducts. According to the present disclosure, the multistage reaction system includes reactors arranged in such a manner that the operating temperature increases toward the subsequent reactor. In this manner, a reactant having a larger carbon number is converted first and the byproduct generated therefrom and having a smaller carbon number is treated sequentially in the reactor connected subsequently, and thus it is convenient that only a syngas composition is obtained finally. In addition, in the multistage catalytic reaction system, the gas flow in the preceding reactor is heated to the reaction temperature and fed directly into the reactor connected subsequently. Therefore, there is an additional advantage in that processing costs required for preheating the reactant is further saved.

The products obtained in the above-mentioned manner can be applied to production of hydrogen and carbon monoxide, Fischer-Tropsch synthesis, methanol synthesis, ammonia synthesis, production of syngas and natural gas, etc. and can be converted into fundamental chemicals of high value, such as polyolefin and polyurethane.

Although Reference 1 discloses an integral multistage reactor, the reaction applicable thereto is the opposite to that applicable to the present disclosure. In other words, Reference 1 is differentiated from the present disclosure in that the reactor of Reference 1 is applied to reaction of carbon monoxide or carbon dioxide with hydrogen for the purpose of synthesis of methane and the temperature of each reactor decreases gradually along the gas flow direction.

Reference 2 and Reference 3 disclose a multistage water gas reaction system for producing hydrogen through reaction of carbon monoxide with water. References 2 and 3 are differentiated from the present disclosure in that the reaction applicable thereto is different from the reaction applicable to the present disclosure and the temperature decreases along the reactant gas flow direction.

Reference 4 also discloses a multistage syngas production system. However, unlike the present disclosure, Reference 4 is applied to a combined reforming in which water steam is fed together with a hydrocarbon feedstock, and each reactor of the system includes a different catalyst, i.e. a pre-reforming catalyst layer, a noble metal enhanced catalyst layer, a nickel-based catalyst layer, sequentially.

### REFERENCES

### Patent Documents

(Patent Document 1) Korean Patent Laid-Open No. 10-2020-0048816

(Patent Document 2) Korean Patent Laid-Open No. 10-2011-0015148

(Patent Document 3) Korean Patent Laid-Open No. 10-2020-0000749

(Patent Document 4) Korean Patent Laid-Open No. 10-2009-0011299

### SUMMARY

The present disclosure is directed to providing a dry reforming reactor for producing hydrogen or syngas through reaction of a mixture of hydrocarbons having various carbon numbers with carbon dioxide. Particularly, the present disclosure is directed to providing a multistage reaction system including a plurality of reaction zones having different operating conditions of reaction parts and connected in series, as an alternative of the process that separates hydrocarbon into components and feeds them into different reactors according to the related art.

In one aspect, there is provided a multistage catalytic reaction system for simultaneous conversion of hydrocarbons having various carbon numbers, including: a reactant supplying part configured to supply reactants containing hydrocarbons and carbon dioxide; a gas reaction part configured to carry out reaction of the reactants on a catalyst and having a plurality of reaction zones connected in series; and a product gas emitting part configured to emit gas produced from the gas reaction part, wherein the hydrocarbons are one or more selected from the group consisting of C₁-C₆ paraffins (CₙH₂ₙ₊₂), naphthenes (CₙH₂ₙ), olefins (CₙH₂ₙ), diolefins (CₙH₂ₙ₋₂), and acetylenes (CₙH₂ₙ₋₂), each reaction zone of the reactor contained in the gas reaction part includes the same catalyst, and temperature of the subsequent reaction zone in the reactor is higher than that of the preceding reaction zone.

The multistage catalytic reaction system according to the present disclosure performs reaction by feeding C₁-C₆ paraffin (CₙH₂ₙ₊₂)-, naphthene (CₙH₂ₙ)-, olefin (CₙH₂ₙ)-, diolefin (CₙH₂ₙ₋₂)- and acetylene (CₙH₂ₙ₋₂)-based hydrocarbons, which are mixed gases emitted actually in the industry, simultaneously. Therefore, it is possible to minimize a gas separation step performed as a pretreatment step before the reaction process.

In addition, the multistage catalytic reaction system according to the present disclosure uses reaction conditions, such as temperature, flow rate, pressure, etc., controlled in each step, and thus each reactant may be subjected to chemical reaction suitable therefor to avoid over-consumption of energy, and syngas and hydrogen may be produced more economically as compared to the conventional catalytic reaction system for conversion of hydrocarbons.

Further, the multistage catalytic reaction system according to the present disclosure allows the product heated in each reactor to be transferred to the next reactor. Therefore, it is possible to reduce waste of heat and to minimize a gas treatment step, thereby providing an effect of increasing the overall processing efficiency and cost efficiency.

The effects of the present disclosure are not limited to the above-mentioned effects. It should be understood that the effects of the present disclosure include all effects that can be inferred from the following description.

### BRIEF DESCRIPTION OF THE DRAWINGS

FIG. 1 is a schematic flow chart of the catalytic reaction system according to Comparative Experimental Example 1 and a graph representing the result of dry reforming in the system.

FIG. 2 is a flow chart of the dry reforming of a feedstock containing a mixture of hydrocarbons having various carbon numbers according to an embodiment of the present disclosure.

FIG. 3 is a schematic view illustrating the six-stage catalytic reaction system for dry reforming of C₁-C₆ hydrocarbons according to an embodiment of the present disclosure.

FIG. 4 is a schematic view illustrating the six-stage catalytic reaction system for dry reforming of C₁-C₆ hydrocarbons according to another embodiment of the present disclosure.

FIG. 5 is a schematic flow chart of the multistage catalytic reaction system for dry reforming of C₁-C₆ mixed hydrocarbons according to an embodiment of the present disclosure and a graph illustrating the amount of each product resulting from the dry reforming in the system.

### DETAILED DESCRIPTION

Hereinafter, the present disclosure will be explained in detail with reference to the accompanying drawings. If there is no other definition of the technical or scientific terminology used in the description, it represents the meaning normally understood by a person with ordinary knowledge in the field to which the invention belongs. In the specification, if it is determined that detailed description of a related known technology may unnecessarily obscure the gist of the present disclosure, the detailed description thereof is omitted.

If “including”, “having”, “formed of” or the like mentioned in the present specification is used, other parts may be added unless “only” is used. In addition, the case of expressing an element in a singular form includes the case of including the plural unless otherwise stated.

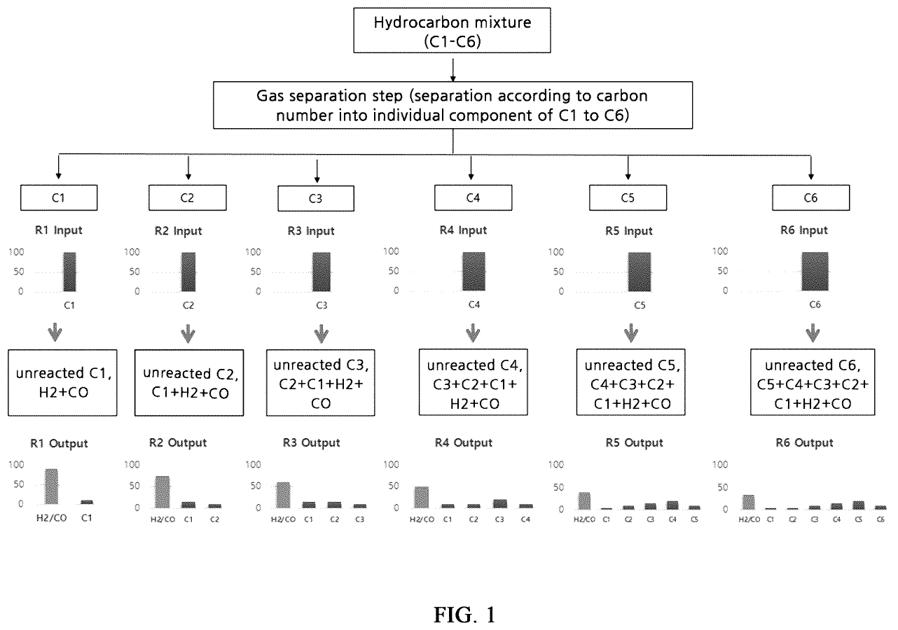

First, a dry reforming reaction system for mixed hydrocarbons according to the related art and the result of dry reforming using the same will be explained with reference to FIG. 1.

FIG. 1 shows a dry reforming reaction system for mixed hydrocarbons according to the related art and the result of dry reforming using the same.

In the dry reforming reaction system for a mixture of hydrocarbons having various carbon numbers, reforming is carried out in a plurality of individual reactors provided with a catalyst, under temperature, pressure, and other operating conditions suitable for reforming each hydrocarbon component having a different carbon number. Therefore, it is required to carry out a step of separating the hydrocarbons in a mixed state into individual hydrocarbons having each carbon number before the mixture is fed into the reactors, but this step is disadvantageous in that it requires a large-scale site and extremely high costs. As a non-limiting example of the method for separating the mixed gas into components, a method using a difference in boiling point, using a separation membrane, using an adsorbent according to pressure swing adsorption (PSA), or the like may be used.

Referring to the bottom portion of FIG. 1, for example, when C₆ hydrocarbons pass through a reforming reactor, all C₆ hydrocarbons are not converted directly into CO and H₂ but a lot of hydrocarbon residues (C₁-C₅) having a smaller carbon number than C₆ hydrocarbons remain. Therefore, there is a problem in that an additional step is required for the purpose of post-treatment.

In addition, as described above, a lot of facility investment is required for separating the hydrocarbon mixture feedstock, and energy for operating such a large-scale separation step is needed. Moreover, since multiple separation steps for separating various unreacted hydrocarbons remaining in each reactor are further required even after the completion of reaction, there is a disadvantage in that a lot of facility investment and extremely high operating costs are required.

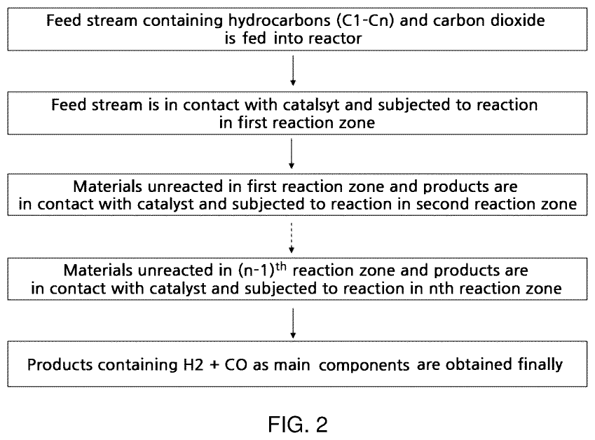

FIG. 2 shows a flow chart of dry reforming using, as a raw material, a gas containing any one of hydrocarbons having various carbon numbers, including paraffins (CₙH₂ₙ₊₂), naphthenes (CₙH₂ₙ), olefins (CₙH₂ₙ), diolefins (CₙH₂ₙ₋₂), acetylenes (CₙH₂ₙ₋₂), etc., or a mixture thereof.

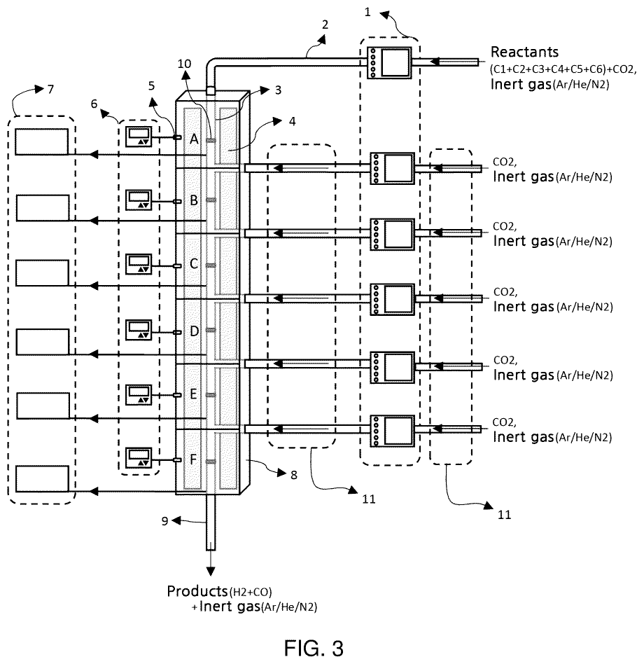

FIG. 3 is a schematic view illustrating an integrally constituted six-stage catalytic reaction system according to an embodiment of the present disclosure, when C₁-C₆ hydrocarbons are supplied as reactants.

In one aspect of the present disclosure, there is provided a multistage catalytic reaction system for finally producing syngas including hydrogen and carbon monoxide through a one-step process by allowing a mixture containing at least one type of hydrocarbon including paraffins (CₙH₂ₙ₊₂), naphthenes (CₙH₂ₙ), olefins (CₙH₂ₙ), diolefins (CₙH₂ₙ₋₂), acetylenes (CₙH₂ₙ₋₂), etc. and carbon dioxide to pass through a dry reforming reaction system including multiple stages of reactors.

In the multistage catalytic reaction system according to the present disclosure, the number of reaction zones and operating conditions, such as temperature and pressure, retention time and flow rate, of each reaction zone may be controlled suitably depending on types and carbon numbers of hydrocarbons contained in the hydrocarbon feedstock. It is possible to control the composition of the product gas at the outlet of each reaction zone and the composition ratio and conversion ratio of the product gas at the final product outlet by controlling such operating conditions.

For example, the multistage catalytic reaction system according to the present disclosure may be divided into reaction zones in the number corresponding to the carbon number of the component having the largest carbon number in the hydrocarbon mixture feedstock fed thereto.

Particularly, referring to FIG. 3, the multistage catalytic reaction system according to the present disclosure may include: a reactant supplying part 2 configured to supply reactants containing hydrocarbons and carbon dioxide; a gas reaction part 8 having a plurality of reaction zones A-F connected in series and having, in each reaction zone, catalyst layers 10, on which reaction of the reactants is occurred; and a product gas emitting part 9 configured to emit gas produced through the gas reaction part 8. In the multistage catalytic reaction system according to the present disclosure, the reactant supplying part 2 is a device configured to supply the hydrocarbons and carbon dioxide as the reactants used for the dry reforming according to the present disclosure to the reaction part 8 provided with a catalyst layer 10, wherein the reactants may be present in a liquid state or gaseous state. When the reactants are in a liquid state, they may be warmed to the vaporization temperature or higher for the reaction and then fed into the reactor in a gaseous state. In addition, although it is not shown in FIG. 3, the reactant supplying part may be further provided with conventional devices, such as a flow meter and flow controller, for controlling the reactant feeding rate.

The gas supplied from the reactant supplying part 2 flows into the multiple stages of the catalytic reactors, and the supplied gas flow may have a direction perpendicular to the catalyst layer 10 included in the reactor.

In the multistage reaction system according to the present disclosure, in each stage of reaction zone, the unreacted reactants and the products (H₂+ CO) discharged from the preceding reaction zone are fed into the subsequent reaction zone connected in series, and the unreacted reactants are converted into hydrocarbons having a smaller carbon number and products under a processing condition different from the processing condition of the preceding stage, thereby maximizing the final conversion ratio and yield of hydrogen (H₂) and carbon monoxide (CO) as final products.

The reaction zones contained in the gas reaction part may include a catalyst layer 10 for accelerating reaction progress, and the catalysts of all reaction zones may be the same or different. Preferably, the catalysts of all reaction zones may be the same.

In addition, the reaction zones may be characterized in that the temperature of the subsequent reaction zone is higher than the temperature of the preceding reaction zone. In general, as the carbon number increases, the temperature condition suitable for reforming tends to decrease. Therefore, the reaction zones may be arranged in such a manner that the temperature of reaction zone increases toward the subsequent stage so that unreacted hydrocarbons or byproduct hydrocarbons having a smaller carbon number produced at the preceding stage may be converted into final products in the subsequent reaction zone having a higher temperature. In this manner, it is possible to minimize reaction residues and to maximize the yield.

Further, the gas flow fed from the preceding stage is heated to a predetermined temperature or above, and thus there are advantages in that heat control is facilitated in the multistage reaction system, in which the temperature increases toward the subsequent stage, and that the operation costs required for heating are minimized. In addition, since the reaction zones having different operating conditions are connected in series, it is possible to obtain products at high yield through a one-step process with no step of separating the hydrocarbon mixture produced from each stage, and thus to obtain an effect of significantly increasing the processing efficiency.

In the multistage catalytic reaction system according to the present disclosure, the hydrocarbons contained in the reactants may be one or more selected from the group consisting of C1-C6 paraffins (CₙH₂ₙ₊₂), naphthenes (CₙH₂ₙ), olefins (CₙH₂ₙ), diolefins (CₙH₂ₙ₋₂), and acetylenes (CₙH₂ₙ₋₂). Herein, n may be 1 to 6 preferably, and 1 to 4 more preferably. For example, the hydrocarbons may include, but are not limited to: one or more selected from the group consisting of methane (CH₄), acetylene (C₂H₂), ethylene (C₂H₄), ethane (C₂H₆), propyne (C₃H₄), propylene (C₃H₆), propane (C₃H₈), butyne (C₄H₆), butene (C₄H₈) and butane (C₄H₁₀). The hydrocarbons may hydrocarbons having substituent groups. For example, the hydrocarbons may include ethanol (C₂H₅OH) having an —OH group.

The hydrocarbons supplied according to the present disclosure may be obtained from byproduct gases or waste gases discharged from actual industrial processes, such as the steel industry, petrochemical industry, oil refining industry, power plants, and painting processes. Byproduct gases discharged from conventional industrial processes may include a mixture of not only C₁ hydrocarbons having one carbon number, but also various hydrocarbons such as C₂-C₄ hydrocarbons and C₅-C₆ hydrocarbons having a larger carbon number depending on the process.

In the multistage catalytic reaction system according to the present disclosure, a ratio of the carbon dioxide to the hydrocarbons in the reactants may be 1:1 to 10:1 based on the total number of carbon atoms, respectively. When the reactants have a composition controlled within the above-defined range, unreacted residues are reduced, and concentration of syngas product is increased to obtain high-purity hydrogen and carbon monoxide products desirably. Herein, carbon dioxide may be fed together with hydrocarbons or from a separate source. In addition, carbon dioxide may be fed through the reactant supplying part totally in an amount required for dry reforming of the hydrocarbons fed herein, or may be fed into the rear end of each reaction zone other than the final reaction zone among multiple reaction zones.

Further, in order to control the concentration of carbon dioxide and hydrocarbons contained in the reactants and the reaction rate, an inert gas (nitrogen, argon, helium, etc., also referred to as carrier gas) may be further supplied together with carbon dioxide to the reactant supplying part or an additional CO₂ feeding part 11 at the rear end of each reaction zone. However, it is advantageous that such a carrier gas is not used, if possible, in order to prevent an increase in costs, such as raw material costs and separation/purification costs.

In the multistage catalytic reaction system according to the present disclosure, the gas reaction part includes a multistage reactor in which a plurality of reaction zones are connected in series and integrated, wherein the catalyst contained in each reactor, hydrocarbons and carbon dioxide participate in reaction to produce syngas including hydrogen and carbon monoxide.

The reactor may be made of quartz, metal (alloy) or a ceramic material capable of preventing shape deformation caused by high temperature.

For example, before starting the reaction, the reactor may be purged by supplying an inert gas, such as nitrogen (N₂), argon (Ar) or helium (He), into the reactor to remove impurities present in the reactor and inhibiting the reaction. The inert gas is supplied preferably at 40-100 cm³/min for 30-60 minutes based on a 20 mm (diameter) quartz tubular reactor. When the diameter of the reactor is increased, it is preferred to increase the flow rate of the inert gas. In addition, when the inert gas fed into the reactor is heated to high temperature and supplied, it is possible to increase the temperature of the reactor while enhancing the effect of removing impurities. Herein, the heating rate is preferably 0.5-30° C./min. For example, the rector may be heated to the temperature of the first reaction zone having the lowest temperature among multiple reaction zones of the reactor by using an inert gas, and then the subsequent zone having a higher reaction temperature may be heated to a target temperature of each reaction zone by using a heating wire and temperature controller provided in each reaction zone.

The catalyst contained in each reaction zone may be further subjected to a reduction step in which the catalyst is treated under hydrogen atmosphere at 300-800° C., before being used for the reaction, so that the performance thereof may be maximized. The reduction step may be carried out by supplying hydrogen into the reactor, and an inert gas may be supplied in combination to control the concentration of hydrogen supplied to the reactor and reduction rate. In the mixed gas of hydrogen with the inert gas, hydrogen is present preferably at 1-20 vol %, and more preferably 3-10 vol %. In addition, the mixed gas of hydrogen with the inert gas is supplied preferably at 10-150 cm³/min for 30-360 minutes based on a quartz tubular reactor having a diameter of 20 mm. However, it is preferred to increase the gas flow rate when the diameter of the reactor is increased.

Each reaction zone is operated preferably under ambient pressure, but the scope of the present disclosure is not limited thereto. Considering the reaction rate and yield, a reduced pressure condition (≤760 Torr) that is equal to or less than ambient pressure or a pressure condition (≥760 Torr) that is equal to or more than ambient pressure may be used.

In the multistage catalytic reaction system according to the present disclosure, the gas reaction part may include reaction zones in the number equal to or larger than the maximum carbon number of the hydrocarbons contained in the reactants. In other words, when paraffin (CₙH₂ₙ₊₂)-, naphthene (CₙH₂ₙ)-, olefin (CₙH₂ₙ)-, diolefin (CnH₂ₙ₋₂)- and acetylene (CₙH₂ₙ₋₂)-based hydrocarbons having n carbon atoms are present in the reactants, at least one reaction zone having operating conditions optimized for the conversion of the other aromatic hydrocarbon reactants may be additionally connected in series in the gas reaction part. Also in this case, when the reaction zones are connected in such a manner that the operating temperature increases from low temperature to high temperature, it is possible to obtain the highest conversion ratio of the reactants and desired yield of products.

In the multistage catalytic reaction system according to the present disclosure, each reaction zone of the gas reaction part may have a temperature of 25 to 1500° C., and the number of reaction zones and the reaction temperature range of each reaction zone may be controlled suitably depending on the type of the catalyst used for the reaction or the types of hydrocarbons contained in the reactants.

For example, in the case of an ambient pressure reaction process using nickel as a catalyst and hydrocarbons including a mixture of CH₄, C₂H₆ and C₃H₈ as reactants, controlling the temperature of the first reaction zone to 500-600° C., that of the second reaction zone to 600-700° C. and that of the third reaction zone to 700-950° C. is preferred, since it can maximize the conversion and yield of products.

In the multistage catalytic reaction system according to the present disclosure, the gas reaction part 8 may include a temperature controller for each reaction zone so that the temperature condition of each reaction zone may be controlled differently.

The temperature controller 6 of each reaction zone is a known technology. For example, the temperature of the catalyst layer of each reaction zone is measured by a thermocouple, and the temperature controller controls the electoral input of a heating device, such as an electric heating element (a heating wire), to control the temperature of each reaction zone to a predetermined value. The temperature controller is not particularly limited, as long as it is one used conventionally, and may include an electric furnace.

Additionally, in the multistage catalytic reaction system according to the present disclosure, the gas reaction part 8 may include a pressure controller for each reaction zone so that the pressure condition of each reaction zone may be controlled differently. The pressure controller is not particularly limited, as long as it is one used conventionally.

Further, the multistage catalytic reaction system according to the present disclosure may further include, although not essential, a gas analyzer 7, such as gas chromatography or mass spectrometer, configured to analyze the emitted gas, at the rear end of each reaction zone of the reaction part.

Meanwhile, if necessary, the product gas composition of each reaction zone is identified in real time through the gas analyzer 7, the amount of CO₂ consumed at the preceding reaction zone and the amount of CO₂ required for the reaction at the subsequent reaction zone are calculated, and then CO₂ may be additionally fed into the reaction zone in a desired amount through an additional CO₂ feeding part 11 to carry out the reaction. In this manner, it is possible to maximize the conversion of hydrocarbons as reactants. Herein, if necessary, an inert gas, such as Ar, He and/or N₂, may be fed together with CO₂ for the purpose of dilution or flow rate control.

In the multistage catalytic reaction system according to the present disclosure, the reaction zones may be arranged in the order that the inner diameter of the reactor contained in the reaction zone decreases as it goes rearwards or in the order opposite thereto. The diameter of the reactor is preferably 5-100 mm in the case of a small-scale laboratory system. In the case of a pilot-scale or more, the inner diameter of the reactor may be 100 mm to 1 m or more, and each reactor may have a different inner diameter so that the flow rate and retention time in each reactor may be controlled. As the diameter of the reactor increases, the amount of reactants fed into the reactor may increase. In addition, as shown in the above Reaction Scheme 1, hydrocarbon conversion is a reaction in which the volume of products is increased as compared to the volume of reactants. Therefore, when the diameter of the reactor decreases as it goes rearwards, the flow rate of reactants may increase significantly and the pressure in the reactor may also increase significantly. On the other hand, when the diameter of the reactor increases as it goes rearwards, the flow rate of gas passing through the reactor may decrease as it goes rearwards or may be similar.

In the multistage reaction system according to the present disclosure, the catalyst contained in the reactor may be used in the form of a single-component catalyst, or alloy or intermetallic compounds, including one or more selected from the group consisting of nickel (Ni), lanthanum (La), gold (Au), cerium (Ce), ruthenium (Ru), rhodium (Rh), palladium (Pd), cobalt (Co), iron (Fe), iridium (Ir), chromium (Cr), gallium (Ga), tungsten (W), rhenium (Re), niobium (Nb), molybdenum (Mo), magnesium (Mg), manganese (Mn), copper (Cu), titanium (Ti), lithium (Li), yttrium (Y), ytterbium (Yb), boron (B), barium (Ba), silver (Ag) and platinum (Pt), and may be used for the reaction in an oxidized state or reduced state.

In addition, when the catalyst component is used in a particle state supported on a support to maximize the active reaction area of the catalyst, the catalyst support may include one or more selected from the group consisting of alumina (Al₂O₃), silica (SiO₂), titania (TiO₂), zirconia (ZrO₂), ceria (CeO₂), magnesia (MgO), lanthania (La₂O₃), baria (BaO), silicon carbide (SiC), carbon black, activated carbon, graphene oxide, graphite, metal organic frameworks (MOFs), zeolites, hydroxyapatite (HAP), MCM-41, SBA-15 and carbon nanotubes.

The amount of the catalyst supported on a support may be controlled suitably during a catalyst preparation process. After preparing a catalyst, the amount or concentration of the catalyst may be controlled by mixing with a support on which no catalyst is supported.

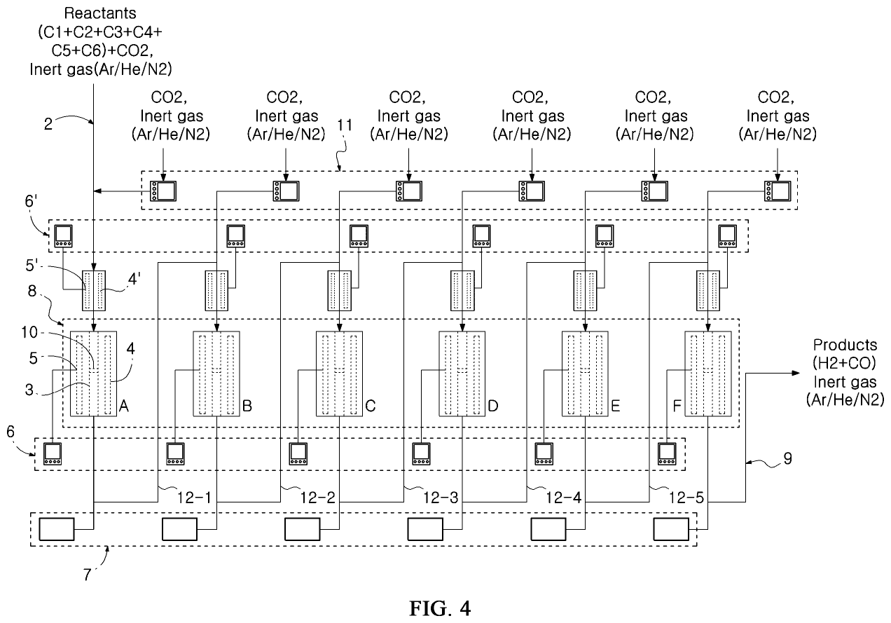

Referring to FIG. 4, a catalytic reaction system for dry reforming of C₁-C₆ hydrocarbons according to another embodiment of the present disclosure will be explained.

Herein, in the configuration of the catalyst reaction system for dry reforming of C₁-C₆ hydrocarbons according to this embodiment, description of the part that is functionally the same as that described above with reference to FIG. 3 will be omitted, and reference will be made to the description related with FIG. 3.

Referring to FIG. 4, the gas reaction part 8 in this embodiment includes six separated reaction zones A to F, and the reactor, heating wire, thermocouple, temperature controller, or the like, forming each reaction zone are the functionally same as the description related with FIG. 3.

In this embodiment, the reaction zones A to F are connected through a reaction zone connecting element 12-1 to 12-5 which connects the outlet of each reaction zone to the inlet of the subsequent reaction zone. The products of the preceding reaction zone are transferred to the subsequent reaction zone through each reaction zone connecting element. Herein, for example, a temperature controlling part 6′ including a heating wire for electric heating, thermocouple and a temperature controller may be optionally provided in each reaction zone connecting element. In this manner, the products of each reaction zone may be heated to a temperature suitable for carrying out dry reforming in the subsequent reaction zone. Herein, the heating wire may be installed in such a manner that it may totally or partially surround each reaction zone connecting element. The size of the portion surrounded by the heating wire may be controlled suitably depending on the size of each reaction zone connecting element, flow rate of internal fluid, difference in temperature between one reaction zone and another reaction zone, or the like.

Meanwhile, the reactant supplying part 2 may be provided with a temperature controlling part having the same function.

In addition, an additional CO₂ feeding part 11 may be connected to the reactant supplying part and each reaction zone connecting element at the front-end, the middle portion or the rear-end of each temperature controlling part. When the amount of CO₂ required for each reaction zone is insufficient, CO₂ may be fed through each additional CO₂ feeding part 11 optionally with an inert gas, such as Ar, He or N₂. The additional CO₂ feeding part 11 is connected preferably to the front-end of each temperature controlling part 6′, since the gases may be preheated to a temperature suitable for each reaction zone before being fed into each reaction zone.

Besides above, for descriptions of common constitutional elements and functions, such as the catalyst filled in each reaction zone, temperature setting of each reaction zone and preheating, reference will be made to the description related with FIG. 3.

Hereinafter, preferred experimental embodiments of the present disclosure will be described so that the present disclosure may be understood with ease. However, it should be understood that such preferred experimental embodiments of the disclosure are given by way of illustration only, and the scope of the present disclosure is not limited thereto. It is apparent to those skilled in the art that various changes and modifications may be made within the scope of the present disclosure.

### EXPERIMENTAL EXAMPLES

### Experimental Example 1. Dry Reforming of C₁-C₆ Hydrocarbons Including All of Paraffins (CₙH₂ₙ₊₂), Naphthenes (CₙH₂ₙ), Olefins (CₙH₂ₙ), Diolefins (CₙH₂ₙ₋₂), Acetylenes (CₙH₂ₙ₋₂), etc. Through Integral Multistage Reaction System

A powdered Ni (10 wt %)/Al₂O₃ catalyst of 0.1 g was placed on a quartz porous filter for supporting the catalyst layer installed at the center of cylindrical quartz reactor of 20 mm in diameter and 400 mm in length. The above cylindrical quartz reactor, each one for each reaction zone, totaling six reactors were connected in series and sealed from the outside air.

The catalyst used was prepared by highly dispersing Nickel(II) nitrate hexahydrate, precursor, onto the Al₂O₃ support by initial wet impregnation method and followed by calcination at 500° C., under oxygen atmosphere for 4 hours to remove the functional groups contained in the precursor.

After removing the impurities by flowing argon gas at 100 cm³/min at room temperature into the reactors in serial for 30 minutes or more, the reactor was warmed up to the target temperature, i.e., 450° C. for the first reaction zone, 550° C. for the second reaction zone, 650° C. for the third reaction zone, 750° C. for the fourth reaction zone, 850° C. for the fifth reaction zone, and 950° C. for the sixth reaction zone, at a rate of 10° C./min under argon atmosphere.

After reaching the target temperature, the dry reforming reaction was started by feeding a gaseous reactant containing a mixture of hydrocarbons C₁-C₆ as follows:

Hydrocarbons containing C₁-C₆ alkanes each mixed in the same amount were fed into the reactor at a flow rate of 100 cm³/min, wherein carbon dioxide gas was mixed with the hydrocarbons at a volume ratio corresponding to 6 times based on the volume of C₆ alkane hydrocarbon (hexane) (i.e. CO₂ was fed at a flow rate of 100 cm³/min) so that the mixed gases were first fed into the first reaction zone at a total flow rate of 200 cm³/min.

The composition of a gas emitted from each reaction zone after the reaction was monitored in real time by using a gas chromatography system equipped with a flame ionization detector and heat conductivity detector and installed between one reaction zone and another reaction zone to calculate an optimized CO₂ concentration required for the reaction in each subsequent reaction zone depending on the composition of the gas emitted from each reaction zone. In addition, the amount of CO₂ consumed in the preceding reactor was calculated, and CO₂ was added to each reaction zone to a desired amount to continue the reaction. For example, after analyzing the gas emitted from zone A in FIG. 3 by using a gas analyzer, it is shown that CO₂ mixed initially at a volume ratio corresponding to 6 times of C₆ alkane hydrocarbon has reacted with C₆ alkane by approximately 90% (90 cm³/min) of the initial amount, while approximately 10% (10 cm³/min) was emitted as unreacted CO₂ state. Therefore, the gas composition ratio was calculated again before being fed into zone B in FIG. 3, and then 73.33 cm³/min of CO₂ was added in such a manner that the flow rate of CO₂ might be 5 times (83.33 cm³/min) of the input volume of C₅ (approximately 16.7 cm³/min). After that, composition analysis was carried out in the same manner as mentioned above for each flow that has passed through reaction zones B, C, D and E, and then CO₂ was fed into the subsequent reactor at the optimum ratio.

After the completion of the reaction, the reactant gas flow was stopped, and the reactor was cooled to room temperature while argon gas was supplied at a rate of 100 cm³/min.

### Experimental Example 2. Dry Reforming of C₁-C₆ Hydrocarbons Including All of Paraffins (CₙH₂ₙ₊₂), Naphthenes (CₙH₂ₙ), Olefins (CₙH₂ₙ), Diolefins (CₙH₂ₙ₋₂), Acetylenes (CₙH₂ₙ₋₂, etc. Through Integral Multistage Reaction System Including Six Reaction Zones Having Different Retention Times

Dry reforming was carried out in the same manner as Experimental Example 1, except that the first reaction zone had an inner diameter of 60 mm, the second reaction zone had an inner diameter of 40 mm, the third reaction zone had an inner diameter of 30 mm, the fourth reaction zone had an inner diameter of 20 mm, the fifth reaction zone had an inner diameter of 10 mm, and the sixth reaction zone had an inner diameter of 5 mm so that each reaction zone might have a different retention time.

### Comparative Experimental Example 1. Dry Reforming of C₁-C₆ Mixed Hydrocarbons Through Conventional Single Reaction System

Dry reforming of C₁-C₆ alkane hydrocarbons was carried out by using a conventional single catalytic reaction system.

Before the C₁-C₆ alkane hydrocarbons were fed into the catalytic reactor, the mixture of C₁-C₆ alkane hydrocarbons was separated into C₁ alkane, C₂ alkane, C₃ alkane, C₄ alkane, C₅ alkane, C₆ alkane individually by using boiling point difference.

Each reactant gas of C₁-C₆ alkanes was fed into a different catalytic reactor set under a reaction condition suitable for each reactant along the respective separated path.

Each catalytic reactor was the same type of catalytic reactor as the catalytic reactor mounted in each reaction zone used in Experimental Example 1. In other words, 0.1 g of the same powdered Ni (10 wt %)/Al₂O₃ catalyst as used in Experimental Example 1 was placed on the filter installed at the center of a cylindrical quartz reactor having a diameter of 20 mm and length of 400 mm, and then reaction was carried out.

Referring to the temperature of each reactor, catalytic reaction was carried out in a methane reforming reactor at 950° C., in an ethane reforming reactor at 800° C., in a propane reforming reactor at 750° C., in a butane reforming reactor at 650° C., in a pentane reforming reactor at 550° C., and in a hexane reforming reactor at 450° C. The reactant in each reactor maintained the concentration of each reactant according to the ratio of hydrocarbon: carbon dioxide as shown in the above Reaction Scheme 1 (i.e. reactants were fed into each reactor at a volume ratio of 1:1 of hydrocarbon:carbon dioxide in the case of C₁, volume ratio of 1:2 of hydrocarbon:carbon dioxide in the case of C₂, volume ratio of 1:3 of hydrocarbon:carbon dioxide in the case of C₃, volume ratio of 1:4 of hydrocarbon:carbon dioxide in the case of C₄, volume ratio of 1:5 of hydrocarbon:carbon dioxide in the case of C₅, and a volume ratio of 1:6 of hydrocarbon:carbon dioxide in the case of C₆ to carry out reaction, and the total reactant flow rate of each reactor was maintained at 100 cm³/min).

The gas emitted after the reaction was monitored in real time by using a gas chromatography equipped with a flame ionization detector and heat conductivity detector. After the completion of the reaction, argon gas was supplied to each reactor at a rate of 100 cm³/min and cooled to room temperature.

### Evaluation of Experimental Results

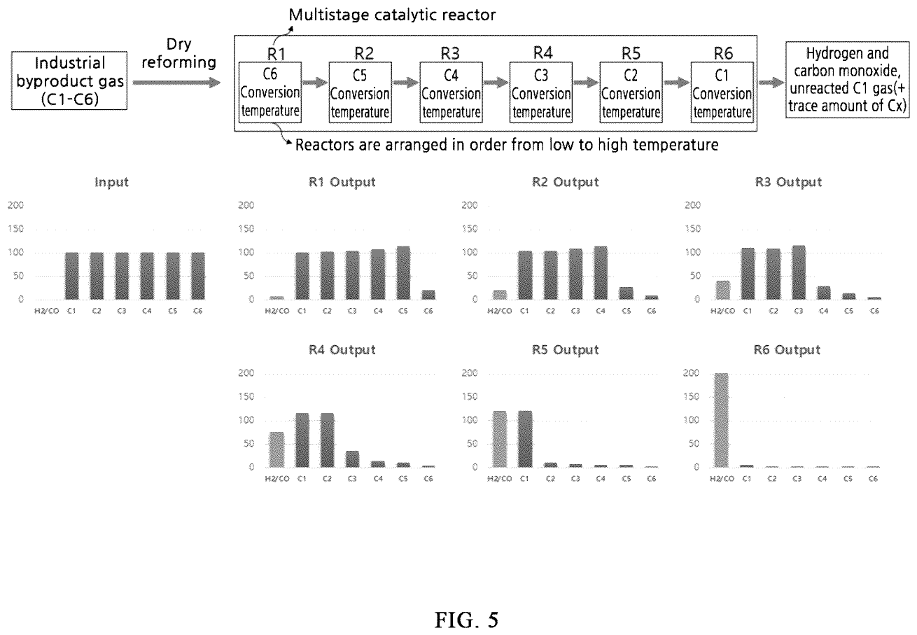

The results of dry reforming of C₁-C₆ mixed hydrocarbons performed according to each of Comparative Experimental Example 1 and Experimental Example 1 will be explained with reference to FIG. 1 and FIG. 5.

As shown in FIG. 5, when dry reforming was carried out by using the multistage catalytic reaction system according to Experimental Example 1, C₁-C₆ hydrocarbon residues remain in a small amount in the final products and most of C₁-C₆ mixed hydrocarbons are converted into H₂/CO. Therefore, it can be seen that Experimental Example 1 provides a higher H₂/CO conversion ratio and yield as compared to the dry reforming performed by using the single catalytic reaction system according to Comparative Experimental Example 1 shown in FIG. 1.

Particularly, referring to FIG. 5, the reaction zones of the multistage catalytic reaction system as shown in FIG. 3 are connected in series, wherein each reaction zone is set to a temperature suitable for hydrocarbon decomposition conformed to the chain length of each hydrocarbon so that dry reforming may occur sequentially while each hydrocarbon having a different carbon number is decomposed into a hydrocarbon having a smaller carbon number. For example, C₆ hydrocarbons are decomposed into C₅ or lower hydrocarbons in the first reaction zone set at a temperature suitable for C₆ hydrocarbon decomposition and dry reforming, the reaction products containing the remaining hydrocarbons are fed into the second reaction zone, C₅ hydrocarbons are decomposed into C₄ or lower hydrocarbons in the second reaction zone set at a temperature suitable for C₅ hydrocarbon decomposition and dry reforming, the reaction products containing the remaining hydrocarbons are fed into the third reaction zone, and such a process is repeated in the third reaction zone to the fifth reaction zone. Then, finally in the sixth reaction zone, C₁ hydrocarbon produced from the preceding reaction zones or unreacted in the preceding reaction zones is subjected to catalytic reaction and converted into the final products, H₂/CO. As a result, it can be seen that little unreacted hydrocarbons remain and a significantly high final conversion ratio and yield are obtained.

On the other hand, in the case of Comparative Experimental Example 1, it can be seen that dry reforming cannot be completed in each reactor, a lot of hydrocarbons are merely subjected to decomposition into hydrocarbons having a smaller number, and thus hydrocarbons still remain. Referring to FIG. 1, in the case of the conventional single catalytic reaction system according to Comparative Experimental Example 1, it is required to carry out a pretreatment step separately to feed hydrocarbons separated according to carbon number through a separation process into each reactor. Therefore, it can be seen that the single catalytic reaction system is inefficient as compared to the present disclosure, and provides a significantly lower final conversion ratio and yield, since each of the separated hydrocarbons cannot be completely converted into a mixture of H₂ with CO and is merely decomposed into a mixture of hydrocarbons having a smaller carbon number as compared to the feed gas, and the hydrocarbon mixture not converted into a syngas state as a final product remains as it is.

In addition, although it is not shown in FIG. 1, the conventional reaction system further requires several separation steps in order to separate the gas mixture produced in each reactor to separate the H₂/CO products from unreacted hydrocarbons, which additionally results in a lot of facility investment and operating cost consumption.

### DESCRIPTION OF ELEMENTS IN DRAWINGS

1: Mass flow controller
2: Reactant supplying part
3: Quartz reactor
4,4′: Heating wire
5,5′: Thermocouple
6,6′: Temperature controller
7: Gas analyzer
8: Gas reaction part
9: Product gas emitting part
10: Catalyst layer
11: Additional CO₂ feeding part
12-1 to 12-5: Reaction zone connecting element
A: First reaction zone
B: Second reaction zone
C: Third reaction zone
D: Fourth reaction zone
E: Fifth reaction zone
F: Sixth reaction zone

What is claimed is:

1. A multistage catalytic reaction system for simultaneous conversion of hydrocarbons having various carbon numbers, comprising:
a reactant supplying part configured to supply reactants containing hydrocarbons and carbon dioxide;
a gas reaction part filled with a catalyst for dry reforming reaction of reactants, and having a plurality of reaction zones configured to carry out the dry reforming reaction of the reactants on the catalyst and connected in series; and
a product gas emitting part configured to emit gas produced through the gas reaction part,
wherein the hydrocarbons are one or more selected from the group consisting of paraffins (CₙH₂ₙ₊₂), naphthenes (CₙH₂ₙ), olefins (CₙH₂ₙ), diolefins (CₙH₂ₙ₋₂) and acetylenes (CₙH₂ₙ₋₂), which may contain a substituent, and
wherein temperature of a subsequent reaction zone is higher than that of a preceding reaction zone.

2. The multistage catalytic reaction system for simultaneous conversion of hydrocarbons having various carbon numbers according to claim 1, wherein an outlet of the preceding reaction zone is directly connected to an inlet of the subsequent reaction zone, or the outlet of the preceding reaction zone is connected to the inlet of the subsequent reaction zone through a reaction zone connecting element.

3. The multistage catalytic reaction system for simultaneous conversion of hydrocarbons having various carbon numbers according to claim 2, wherein an additional CO₂ feeding part through which CO₂ and/or an inert gas can be fed is connected to the inlet of at least one of the reaction zones.

4. The multistage catalytic reaction system for simultaneous conversion of hydrocarbons having various carbon numbers according to claim 2, wherein a temperature controlling part is installed in at least one of the reaction zone connecting elements, and an additional CO₂ feeding part through which CO₂ and/or an inert gas can be fed is connected to the reaction zone connecting element at a position in front of the position where the temperature controlling part is installed.

5. The multistage catalytic reaction system for simultaneous conversion of hydrocarbons having various carbon numbers according to claim 1, wherein the hydrocarbons comprise one or more selected from the group consisting of paraffins (CₙH₂ₙ₊₂), naphthenes (CₙH₂ₙ), olefins (CₙH₂ₙ), diolefins (CₙH₂ₙ₋₂) and acetylenes (CₙH₂ₙ₋₂), wherein n is 1 to 6.

6. The multistage catalytic reaction system for simultaneous conversion of hydrocarbons having various carbon numbers according to claim 1, wherein the reactants comprise a mixture of carbon dioxide with hydrocarbons mixed at a ratio of 1:1 to 10:1 based on the total number of carbon atoms in the carbon dioxide and hydrocarbons, respectively.

7. The multistage catalytic reaction system for simultaneous conversion of hydrocarbons having various carbon numbers according to claim 6, wherein carbon dioxide is fed together with the hydrocarbons, or from a separate source.

8. The multistage catalytic reaction system for simultaneous conversion of hydrocarbons having various carbon numbers according to claim 1, wherein the gas reaction part is divided into a number of reaction zones equal to or greater than the number of carbon atoms of the hydrocarbon having the largest carbon number among the hydrocarbons contained in the reactants.

9. The multistage catalytic reaction system for simultaneous conversion of hydrocarbons having various carbon numbers according to claim 8, wherein temperature of the gas reaction part is in the range of 25° C. to 1500° C.

10. The multistage catalytic reaction system for simultaneous conversion of hydrocarbons having various carbon numbers according to claim 1, wherein the temperature of each reaction zone in the gas reaction part increases gradually.

11. The multistage catalytic reaction system for simultaneous conversion of hydrocarbons having various carbon numbers according to claim 1, wherein each reaction zone in the gas reaction part is set under a different pressure.

12. The multistage catalytic reaction system for simultaneous conversion of hydrocarbons having various carbon numbers according to claim 1, wherein each reaction zone in the gas reaction part has an inner diameter of reactor increasing gradually, decreasing gradually, or changing irregularly.

13. The multistage catalytic reaction system for simultaneous conversion of hydrocarbons having various carbon numbers according to claim 1, wherein the catalyst is used in the form of a single-component catalyst, alloy or intermetallic compounds comprising one or more selected from the group consisting of nickel (Ni), lanthanum (La), gold (Au), cerium (Ce), ruthenium (Ru), rhodium (Rh), palladium (Pd), cobalt (Co), iron (Fe), iridium (Ir), chromium (Cr), gallium (Ga), tungsten (W), rhenium (Re), niobium (Nb), molybdenum (Mo), magnesium (Mg), manganese (Mn), copper (Cu), titanium (Ti), lithium (Li), yttrium (Y), ytterbium (Yb), boron (B), barium (Ba), silver (Ag) and platinum (Pt).

14. The multistage catalytic reaction system for simultaneous conversion of hydrocarbons having various carbon numbers according to claim 13, wherein the catalyst is supported on at least one support selected from the group consisting of alumina (Al₂O₃), silica (SiO₂), titania (TiO₂), zirconia (ZrO₂), ceria (CeO₂), magnesia (MgO), lanthania (La₂O₃), baria (BaO), silicon carbide (SiC), carbon black, activated carbon, graphene oxide, graphite, metal organic frameworks (MOFs), zeolites, hydroxyapatite (HAP), MCM-41, SBA-15 and carbon nanotubes.

15. The multistage catalytic reaction system for simultaneous conversion of hydrocarbons having various carbon numbers according to claim 1, wherein the catalyst is a metal catalyst without support, a metal catalyst supported on a support, or a mixture of a support in which no catalyst component is supported and at least one of the metal catalyst supported or not.
